(19) United States
(12) Patent Application Publication
(10) Pub. No.: US 2014/0313155 A1
(43) Pub. Date: Oct. 23, 2014

(54) Stylus with Voice Capability

(71) Applicant: Esat Yilmaz, Santa Cruz, CA (US)

(72) Inventor: Esat Yilmaz, Santa Cruz, CA (US)

(21) Appl. No.: 13/864,418

(22) Filed: Apr. 17, 2013

(51) Int. Cl. G06F 3/0354; G06F 3/16; G06F 3/044

(52) U.S. Cl. CPC G06F 3/03545; G06F 3/044; G06F 3/16
USPC 345/174

(57) ABSTRACT

In one embodiment, a method comprises transmitting a first electrical signal to a tip of a stylus, the first electrical signal configured to modify a charge at one or more capacitive nodes of a touch sensor of a computing device such that the proximity of the stylus to the one or more capacitive nodes may be detected by the computing device. A first audio signal is generated based on a first set of sound waves received at a microphone of the stylus. The first audio signal is encoded and wirelessly transmitted to the computing device. A second audio signal received wirelessly from the computing device is decoded and a second set of sound waves based on the decoded second audio signal is played.

### TECHNICAL FIELD

This disclosure relates generally to touch sensors.

### BACKGROUND

A touch sensor may detect the presence and location of a touch or the proximity of an object (such as a user's finger or a stylus) within a touch-sensitive area of the touch sensor overlaid on a display screen, for example. In a touch-sensitive-display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

### BRIEF DESCRIPTION OF THE DRAWINGS

FIG. 1 illustrates an example device that includes an example touch sensor and an example touch-sensor controller.

FIG. 2 illustrates an example exterior of an example active stylus that may be used with the device of FIG. 1.

FIG. 3 illustrates example interior components of the active stylus of FIG. 2.

FIG. 4 illustrates the active stylus of FIG. 2 with an example device that includes the touch sensor and controller of FIG. 1.

FIG. 5 illustrates an example method for providing voice capability by the active stylus of FIG. 2.

### DESCRIPTION OF EXAMPLE EMBODIMENTS

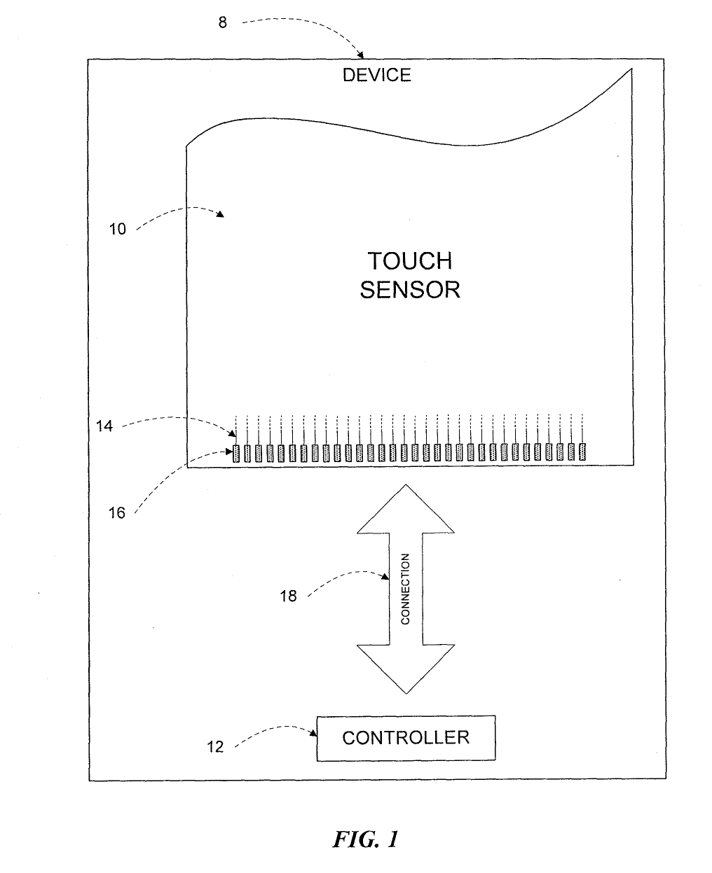

FIG. 1 illustrates an example device 8 that includes an example touch sensor 10 and an example touch-sensor controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a ground electrode, a guard electrode, a drive electrode, or a sense electrode) may be an area of conductive material forming a shape, such as for example a disc, square, rectangle, thin line, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of a transparent material such as indium tin oxide (ITO) and the ITO of the electrode may occupy approximately 100% of the area of its shape (sometimes referred to as 100% fill), where appropriate. In particular embodiments, the conductive material of an electrode may occupy substantially less than 100% of the area of its shape. As an example and not by way of limitation, an electrode may be made of one or more opaque materials such as fine lines of metal or other conductive material (FLM), such as for example copper, silver, or a copper- or silver-based material, and the fine lines of conductive material may occupy approximately 5% of the area of its shape in a hatched, mesh, or other suitable pattern. Herein, reference to FLM encompasses such material, where appropriate. Although this disclosure describes or illustrates particular electrodes made of particular conductive material forming particular shapes with particular fill percentages having particular patterns, this disclosure contemplates any suitable electrodes made of any suitable conductive material forming any suitable shapes with any suitable fill percentages having any suitable patterns.

Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of device 8. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

In particular embodiments, the mechanical stack containing the substrate and the drive or sense electrodes may be formed within a display panel (thus forming an in-cell sensor) or on a display panel (thus forming an on-cell sensor). In an in-cell sensor, the display may be on the same substrate as the drive or sense electrodes. The display panel may be a liquid crystal display (LCD), a light-emitting diode (LED) display, an LED-backlight LCD, or other suitable electronic display and may be visible through the touch sensor 10 that provides the touch-sensitive area. Although this disclosure describes particular display types, this disclosure contemplates any suitable display types.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such one or more central processing units (CPUs)) of a device 8 that includes touch sensor 10 and touch-sensor controller 12, which may respond to the touch or proximity input by initiating a function of the device (or an application running on the device). Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. For example, controller 12 may include a computer-readable storage medium storing logic that when executed by a processor is operable to perform one or more functions of controller 12 described herein. In particular embodiments, touch-sensor controller 12 is disposed on a flexible printed circuit (FPC) bonded to the substrate of touch sensor 10, as described below. The FPC may be active or passive, where appropriate. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

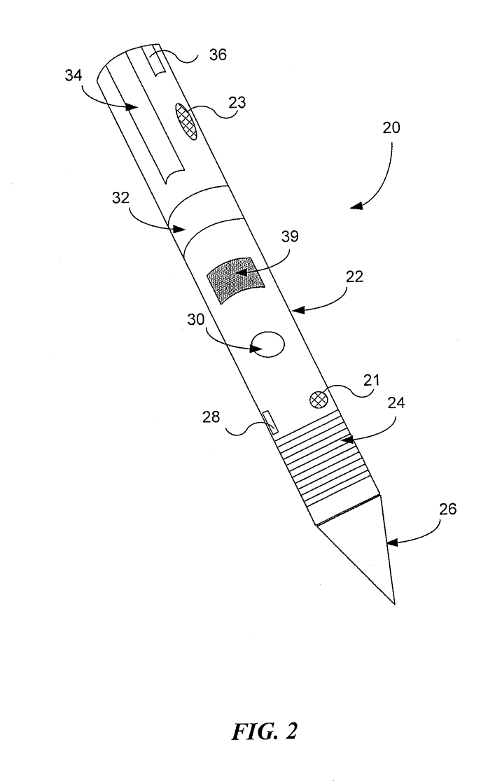

FIG. 2 illustrates an example exterior of an example active stylus 20 that may be used with device 8 of FIG. 1. For example, active stylus 20 may be used to enter input into a device 8 that includes a touch sensor 10 and controller 12, such as a desktop computer, laptop computer, tablet computer, personal digital assistant (PDA), smartphone, satellite navigation device, portable media player, portable game console, kiosk computer, point-of-sale device, or other suitable device. Device 8 may be connected to one or more networks such as a cellular network, the Internet, a private network, or other suitable networks. Device 8 may provide functionality to support a voice call between device 8 and another device coupled to the one or more networks. This disclosure contemplates device 8 supporting any appropriate type of voice call, such as for example a video or telephone call, over any appropriate network, such as for example the public switched telephone network or the Internet (e.g., voice over Internet Protocol). For example, device 8 may support telephone calls over the Internet using voice over Internet Protocol. Various devices, such as tablet computers, generally do not include convenient audio interfaces for facilitating calls. For example, the audio interface of the device may prevent the user from having a private conversation due to the broadcast nature of the speaker of the device. Furthermore, it may be difficult or awkward for a user of a tablet computer to hold the tablet computer up to his ear or mouth during the call. Various embodiments of the present disclosure include an active stylus 20 that provides voice capabilities. That is, active stylus 20 may include audio components that receive sound waves and transmit a representation of the sound waves to device 8. Active stylus 20 may also receive representations of sound waves from the device 8 (which receives them from one or more other participants of the voice call via one or more networks) and play the sound waves via one or more speakers. In particular embodiments, active stylus 20 includes a microphone and a speaker that are spaced apart such that the speaker may be placed near the ear of a user and the microphone may be placed near a mouth of the user. Accordingly, a user of device 8 may participate in a voice call via active stylus 20 without having to utilize an additional device, such as a headset.

Active stylus 20 may be powered (e.g., by an internal or external power source) and is capable of providing touch or proximity inputs to a touch sensor 10. For example, active stylus 20 may generate a drive signal that induces a change in charge at on or more capacitive nodes of touch sensor 10. When active stylus 20 is placed near touch sensor 10, touch-sensor controller 12 detects the presence of the active stylus 20 by detecting a change in charge present at one or more capacitive nodes of the touch sensor. In various embodiments, touch-sensor controller 12 may distinguish between touches made by active stylus 20 and touches made by a passive object, such as a human finger, even if the touches occur simultaneously.

Any suitable drive signal may be generated by active stylus 20. For example, the drive signal may include one or more pulses or may be a sinusoidal or square wave. The drive signal may have any suitable frequency content. For example, in a particular embodiment, the drive signal may have a dominant frequency that is different from one or more dominant frequencies of drive signals generated by controller 12. Active stylus 20 may periodically generate a drive signal or may generate a drive signal in response to a stimulus. For example, in particular embodiments, active stylus 20 is operable to detect a signal transmitted to one or more drive lines of touch sensor 10 by controller 12 and to generate a drive signal in response to the detection of the signal from controller 12. The signal from controller 20 may be detected in any suitable manner. For example, active stylus 20 may detect the signal by detecting one or more voltage spikes of the signal. In various embodiments, the drive signal generated by active stylus 20 is based on the signal from controller 12. For example, active stylus 20 may sense the signal from controller 12, filter the signal, amplify the filtered signal, store the filtered signal, identify the presence of a triggering condition, and release the stored signal as the drive signal of active stylus 20. As other examples, active stylus 20 may invert the phase, raise the voltage, or otherwise process the signal from controller 12 to generate the drive signal.

One or more components of active stylus 20 may be configured to communicate signals between active stylus 20 and device 8. For example, active stylus 20 may include one or more tips 26 or nibs. Tip 26 may include one or more electrodes configured to communicate signals between active stylus 20 and one or more devices or other active styluses. In various embodiments, tip 26 may communicate one or more drive signals that affect the amount of charge stored at one or more capacitive nodes of touch sensor 10. In particular embodiments, tip 26 may provide or communicate pressure information (e.g., the amount of pressure being exerted by active stylus 20 through tip 26) between active stylus 20 and one or more devices or other active styluses. Tip 26 may be made of any suitable material, such as a conductive material, and have any suitable dimensions, such as, for example, a diameter of 1 mm or less at its terminal end.

Active stylus 20 may include one or more audio components capable of transmitting and receiving sound waves. In the embodiment depicted, active stylus includes a microphone 21 and speaker 23. Microphone 21 may be capable of receiving sound waves and converting the sound waves into an audio signal. For example, microphone 21 may capture the voice of a user of active stylus 20 during a call or a recording and convert the voice to an analog electrical signal. The microphone 21 may then transmit the audio signal to an audio codec of active stylus 20 for encoding. In particular embodiments, the encoded signal may be sent to device 8 or stored locally by active stylus 20. Speaker 23 may be capable of receiving an audio signal (e.g., an electrical analog signal) and converting the audio signal into sound waves that are transmitted from active stylus 20 (e.g., towards a user). Speaker 23 may be capable of playing any suitable audio signal. As an example, speaker 23 may play an audio portion of a call between device 8 and another endpoint. As another example, speaker 23 may play an audio file (e.g., a compressed music file) that is stored persistently or temporarily by device 8 or by active stylus 20. As another example, speaker 23 may provide an auditory indication on an incoming or outgoing voice call. As yet another example, speaker 23 may provide an auditory indication of a power status of active stylus 20.

Active stylus 20 may include one or more components, such as one or more buttons 30 or sliders 32 and 34 integrated with an outer body 22. These external components may provide for interaction between active stylus 20 and a user or between a device 8 and a user. As an example and not by way of limitation, interactions may include communication between active stylus 20 and device 8, enabling or altering functionality of active stylus 20 or device 8, or providing feedback to or accepting input from one or more users. Although this disclosure provides specific examples of particular components configured to provide particular interactions, this disclosure contemplates any suitable component configured to provide any suitable interaction. Active stylus 20 may have any suitable dimensions with outer body 22 made of any suitable material or combination of materials, such as, for example and without limitation, plastic or metal. In particular embodiments, exterior components (e.g. 30 or 32) of active stylus 20 may interact with internal components or programming of active stylus 20 or may initiate one or more interactions with one or more devices or other active styluses 20.

As described above, actuating one or more particular components may initiate an interaction between active stylus 20 and a user or between the device 8 and the user. Components of active stylus 20 may include one or more buttons 30 or one or more sliders 32 and 34. As an example and not by way of limitation, buttons 30 or sliders 32 and 34 may be mechanical or capacitive and may function as a roller, trackball, or wheel. As another example, one or more vertical sliders 34 may be aligned along a longitudinal axis of active stylus 20, while one or more wheel sliders 32 may be aligned around the circumference of active stylus 20. In particular embodiments, capacitive sliders 32 and 34 or buttons 30 may be implemented using one or more touch-sensitive areas. Touch-sensitive areas may have any suitable shape, dimensions, location, or be made from any suitable material. As an example and not by way of limitation, sliders 32 and 34 or buttons 30 may be implemented using areas of flexible mesh formed using lines of conductive material. As another example, sliders 32 and 34 or buttons 30 may be implemented using a FPC.

The actions initiated by actuating one or more particular components such as buttons 30 or sliders 32 and 34 may be dependent on a mode of active stylus 20. For example, actuating a button may initiate a particular action when active stylus 20 operates in a first mode and a different action when active stylus 20 operates in a second mode. Active stylus 20 may operate in any suitable number of modes. In various embodiments, active stylus 20 may operate in one or more of a stylus mode, a call mode, a hybrid mode in which various functions of the stylus mode and call mode are available, or a mouse mode. In particular embodiments, the stylus mode of active stylus 20 may allow active stylus 20 to provide touch or proximity inputs to touch sensor 10. Active stylus 20 may transition to a call mode or the hybrid mode when a voice call is routed through active stylus 20 or a voice call is initiated and may revert back to the stylus mode when the call has ended. In the call mode, actuation of a button 30 or slider 32 or 34 may initiate an action of active stylus 20 or device 8 that is related to a voice call. For example, the action may include answering an incoming voice call, initiating a voice call, ending a voice call, changing the volume of speaker 23, muting or unmuting microphone 21, placing the voice call on hold, or other suitable action. In the stylus mode, actuation of a button 30 or slider 32 or 34 may initiate another suitable action such as toggling power to active stylus 20, thereby turning active stylus 20 on or off. In the mouse mode, actuation of a button 30 or slider 32 or 34 may result in a mouse click of an object displayed on the display of device 8 or the movement of a webpage displayed on a display of device 8. In particular embodiments, the association between a component and the initiated action for each mode may be customizable by the user. Although this disclosure describes associating particular pre-determined functions with distinct touch-sensitive areas for particular operating modes of the active stylus, this disclosure contemplates associating any suitable pre-determined function with distinct touch-sensitive areas for any suitable operating mode of the active stylus.

In particular embodiments, the controller of active stylus 20 detects and processes a touch or proximity input that is a movement substantially within distinct touch-sensitive areas 32 or 34 to initiate the particular pre-determined function of active stylus 20 associated with the particular touch-sensitive area 32 or 34. As an example and not by way of limitation, in the mouse mode a substantially rectangular touch-sensitive area 32 of the touch sensor located around the circumference of the form factor of active stylus 20 may function as a wheel slider. As another example, a touch or proximity input that is a movement substantially within substantially rectangular touch-sensitive area 34 may toggle power to active stylus 20, thereby turning active stylus 20 on or off. In other particular embodiments, the controller of active stylus 20 may detect and processes a touch or proximity input that is a movement substantially within distinct touch-sensitive area (e.g. 34) to initiate communication between active stylus 20 and device 8, where the communication corresponds to the pre-determined function associated with the particular touch-sensitive area (e.g. 34). As an example and not by way of limitation, a touch or proximity input that is a movement within substantially rectangular touch-sensitive area 34 may initiate movement of a cursor displayed on the display of device 8.

Active stylus 20 may include one or more ports 28 located at any suitable location on outer body 22 of active stylus 20. Port 28 may be configured to transfer signals or information between active stylus 20 and one or more devices or power sources via, for example, wired coupling. Port 28 may transfer signals or information by any suitable technology, such as, for example, by universal serial bus (USB) or Ethernet connections.

Active stylus 20 may have one or more components configured to provide feedback to or accept feedback from a user, such as, for example and without limitation, tactile, visual, or audio feedback. Active stylus 20 may include one or more ridges or grooves 24 on its outer body 22. Ridges or grooves 24 may have any suitable dimensions, have any suitable spacing between ridges or grooves, or be located at any suitable area on outer body 22 of active stylus 20. As an example and not by way of limitation, ridges 24 may enhance a user's grip on outer body 22 of active stylus 20 or provide tactile feedback to or accept tactile input from a user. Active stylus 20 may include one or more visual feedback components 36, such as a light-emitting diode (LED) indicator or electrophoretic ink (E-Ink). As an example and not by way of limitation, visual feedback component 36 may indicate a power status of active stylus 20 to the user.

One or more modified surface areas 39 may form one or more components on outer body 22 of active stylus 20. Properties of modified surface areas 39 may be different than properties of the remaining surface of outer body 22. As an example and not by way of limitation, modified surface area 39 may be modified to have a different texture, temperature, or electromagnetic characteristic relative to the surface properties of the remainder of outer body 22. Modified surface area 39 may be capable of dynamically altering its properties, for example by using haptic interfaces or rendering techniques. A user may interact with modified surface area 39 to provide any suitable functionally. For example and not by way of limitation, dragging a finger across modified surface area 39 may initiate an interaction, such as data transfer, between active stylus 20 and a device 8.

Although this disclosure describes and illustrates a particular configuration of particular components with particular locations, dimensions, composition and functionality, this disclosure contemplates any suitable configuration of suitable components with any suitable locations, dimensions, composition, and functionality with respect to active stylus 20.

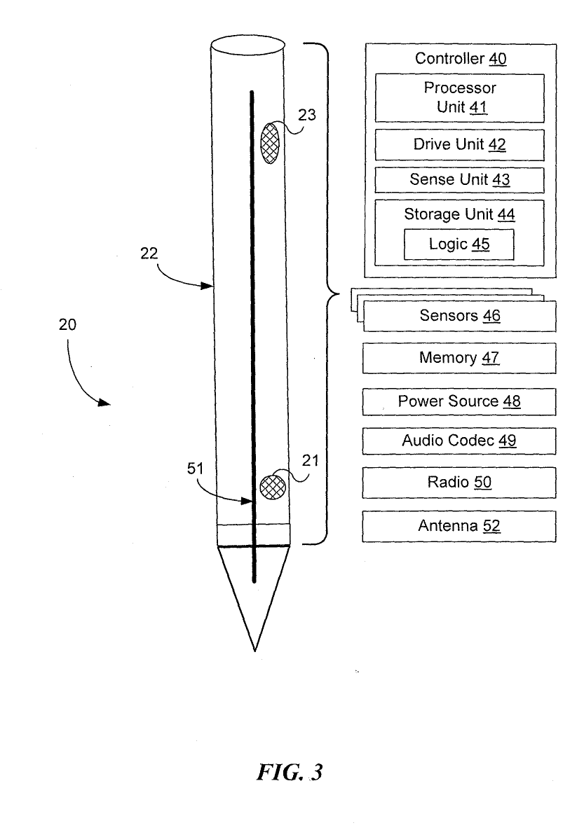

FIG. 3 illustrates example internal components of the active stylus 20 of FIG. 2. Active stylus 20 includes one or more internal components, such as a controller 40, sensors 46, memory 47, power source 48, audio codec 49, radio 50, or antenna 52. In particular embodiments, one or more internal components may be configured to provide for interaction between active stylus 20 and a user or device 8. In other particular embodiments, one or more internal components, in conjunction with one or more external components described above, may be configured to provide interaction between active stylus 20 and a user or device 8. As an example and not by way of limitation, interactions may include communication between active stylus 20 and device 8, enabling or altering functionality of active stylus 20 or device 8, or providing feedback to or accepting input from one or more users. As another example, active stylus 20 may communicate via any applicable short distance data transmission or modulation link, such as, for example and without limitation, via a radio frequency (RF) communication link.

Controller 40 may be a microcontroller or any other type of processor suitable for controlling the operation of active stylus 20. Controller 40 may be one or more ICs—such as, for example, general-purpose microprocessors, microcontrollers, programmable logic devices (PLDs), programmable logic arrays (PLAs), or ASICs. Controller 40 may include a processor unit 41, a drive unit 42, a sense unit 43, and a storage unit 44. The drive unit 42 may supply signals to electrodes of tip 26 through center shaft 51. The drive unit 42 may also supply signals to control or drive sensors 46 or one or more external components of active stylus 20. The sense unit 43 may sense signals received by electrodes of tip 26 through center shaft 51 and provide measurement signals to the processor unit 41 representing input from device 8. The sense unit 43 may also sense signals generated by sensors 46 or one or more external components of device 8 and provide measurement signals to the processor unit 41 representing input from a user. The processor unit 41 may control the supply of signals to the electrodes of tip 26 and process measurement signals from the sense unit 43 to detect and process input from the device 8. The processor unit 41 may also process measurement signals from sensors 46 or one or more external components.

The storage unit 44 may store programming for execution by the processor unit 41. For example, storage unit 44 may store logic 45 that is operable when executed to perform various functions described herein, such as controlling the drive unit 42 to supply signals to the electrodes of tip 26, processing measurement signals from the sense unit 43 corresponding to input from the device 8, processing measurement signals from sensors 46 or external components to initiate a pre-determined function or gesture to be performed by active stylus 20 or device 8, performing functions facilitating a voice call, and other suitable programming, where appropriate. As an example and not by way of limitation, programming executed by controller 40 may electronically filter signals received from the sense unit 43. Although this disclosure describes a particular controller 40 having a particular implementation with particular components, this disclosure contemplates any suitable controller having any suitable implementation with any suitable components.

In particular embodiments, active stylus 20 may include one or more sensors 46, such as touch sensors, gyroscopes, accelerometers, contact sensors, or any other types of sensors that detect or measure data about the environment in which active stylus 20 operates. Sensors 46 may detect and measure one or more characteristic of active stylus 20, such as acceleration or movement, orientation, contact, pressure on outer body 22, force on tip 26, vibration, or any other suitable characteristic of active stylus 20. As an example and not by way of limitation, sensors 46 may be implemented mechanically, electronically, or capacitively. In particular embodiments, sensors 46 may correspond to or interact with buttons 30, sliders 32 and 34, or modified surface area 39. As described above, data detected or measured by sensors 46 communicated to controller 40 may initiate a pre-determined function or gesture to be performed by active stylus 20 or the device 8. In particular embodiments, the pre-determined function or gesture initiated by a particular sensor 46 may be dependent on a mode in which active stylus 20 is operating. For example, in a first mode a particular function may be initiated and in a second mode a different function may be initiated.

Memory 47 may be any form of memory suitable for storing data in active stylus 20. Memory 47 may be any form of volatile or non-volatile memory including, without limitation, magnetic media, optical media, random access memory (RAM), read-only memory (ROM), flash memory, removable media, or any other suitable local or remote memory component or components. Memory 47 may store any suitable data or information utilized by active stylus 20, including software embedded in a computer readable medium, and/or encoded logic incorporated in hardware or otherwise stored (e.g., firmware) such as any of the information described above with respect to the programming of storage unit 44. In particular embodiments, data detected or received by sensors 46 or radio 50 may be stored in memory 47. As another example, data detected by sensors 46 or radio 50 may be processed by controller 40 or audio codec 49 and stored in memory 47. In particular embodiments, controller 40 or audio codec 49 may access data stored in memory 47.

Power source 48 may be any type of stored-energy source, including electrical or chemical-energy sources, suitable for powering the operation of active stylus 20. In particular embodiments, power source 48 may be charged by energy from a user or device 8. As an example and not by way of limitation, power source 48 may be a rechargeable battery that may be charged by motion induced on active stylus 20. In other particular embodiments, power source 48 of active stylus 20 may provide power to or receive power from the device 8 or other external power source. As an example and not by way of limitation, power may be inductively transferred between power source 48 and a power source of the device 8 or another external power source, such as a wireless power transmitter. Power source 48 may also be powered by a wired connection through an applicable port coupled to a suitable power source.

Audio codec 49 is operable to encode an audio signal (e.g., an analog electrical signal) received from one or more microphones 21 into a digital signal. In particular embodiments, audio codec 49 employs one or more analog-to-digital converters (ADCs) to convert the audio signal to a digital signal. Audio codec 49 may use any suitable type of encoding, such as lossy compression or lossless compression. Audio codec 49 may also be operable to decode a digital signal into an audio signal. In particular embodiments, audio code 49 employs one or more digital-to-analog converters (DAC) to convert the audio signal to a digital signal. In particular embodiments, audio code 49 may also encrypt an encoded digital signal or decrypt a received digital signal before converting the signal into an audio signal. Audio codec 49 may include any suitable hardware or software and in various embodiments may be implemented separate from or integrated with controller 40.

Active stylus 20 may also comprise a radio 50 and antenna 52 for wireless communication. Radio 50 may be coupled to or a part of antenna 52. Radio 50 may receive digital data that is to be sent out to a device, such as device 8, via a wireless connection. Radio 50 may convert the digital data into a radio signal having the appropriate frequency and bandwidth parameters. Any suitable radio signal may be used. In particular embodiments, the radio signal has a bandwidth that is suitable to communicate voice data between active stylus 20 and device 8. In particular embodiments, the radio signal may conform to a short-range wireless communication specification, such as Bluetooth (e.g., IEEE 802.15.1), ZigBee, Ultra-Wideband (UWB), Wi-Fi (e.g., IEEE 802.11), or other suitable specification. The radio signal may then be transmitted via antenna 52 for receipt by any appropriate component or device (e.g., device 8). Similarly, radio 50 may convert radio signals received from antenna 52 into digital data to be processed by controller 40. The received radio signals may also conform to any suitable short-range wireless communication protocol such as those described above. Radio 50 may include any suitable hardware or software and in various embodiments may be implemented separate from or integrated with controller 40.

Antenna 52 may be any type of antenna capable of transmitting and receiving data and/or signals wirelessly. Antenna 52 may comprise one or more omni-directional, sector, or panel antennas operable to transmit or receive radio signals having any suitable frequencies, such as between 900 MHz and 10.6 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. Radio 50 and antenna 52 may collectively form a wireless interface. This wireless interface may be used to establish connections with various wireless components, including devices (e.g., device 8) or wireless interfaces of other active styluses 20.

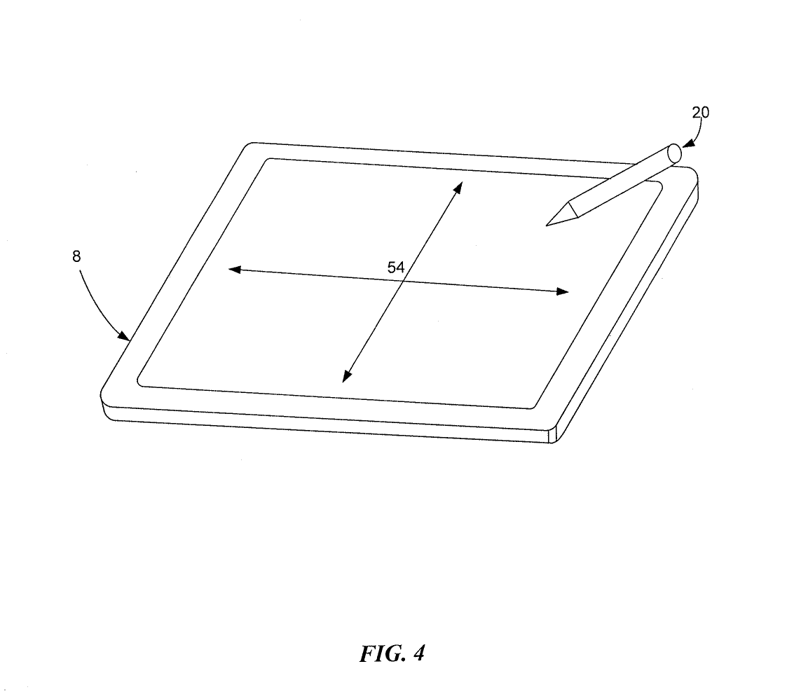

FIG. 4 illustrates an example active stylus 20 being used with device 8. Device 8 may have a display (not shown) and one or more touch sensors 10 implementing a touch-sensitive area 54. The display of device 8 may be a liquid crystal display (LCD), a LED display, a LED-backlight LCD, or other suitable display and may be visible though a cover panel and substrate (and the drive and sense electrodes of the touch sensor disposed on it) of device 8. Although this disclosure describes a particular device display and particular display types, this disclosure contemplates any suitable device display and any suitable display types.

Device 8 electronics may provide the functionality of device 8. As example and not by way of limitation, device 8 electronics may include circuitry or other electronics for wired or wireless communication to or from device 8, execute programming on device 8, generating graphical or other user interfaces (UIs) for device 8 display to display to a user, managing power to device 8 from a battery or other power source, executing a voice call with another device, taking still pictures, recording video, other suitable functionality, or any suitable combination of these. Although this disclosure describes particular device electronics providing particular functionality of a particular device, this disclosure contemplates any suitable device electronics providing any suitable functionality of any suitable device.

In particular embodiments, active stylus 20 and device 8 may be synchronized prior to communication of data between active stylus 20 and device 8. As an example and not by way of limitation, active stylus 20 may be synchronized to device 8 through a pre-determined bit sequence transmitted by the touch sensor of device 8. As another example, active stylus 20 may be synchronized to device by processing the drive signal transmitted by drive electrodes of the touch sensor of device 8. Active stylus 20 may interact or communicate with device 8 when active stylus 20 is brought in contact with or in proximity to touch-sensitive area 54 of the touch sensor of device 8. In particular embodiments, interaction between active stylus 20 and device 8 may be capacitive or inductive. As an example and not by way of limitation, when active stylus 20 is brought in contact with or in the proximity of touch-sensitive area 54 of device 8, signals generated by active stylus 20 may influence capacitive nodes of touch-sensitive area of device 8 or vice versa. As another example, a power source of active stylus 20 may be inductively charged through the touch sensor of device 8, or vice versa. Although this disclosure describes particular interactions and communications between active stylus 20 and device 8, this disclosure contemplates any suitable interactions and communications through any suitable means, such as mechanical forces, current, voltage, or electromagnetic fields.

In particular embodiments, measurement signals from the sensors 46 of active stylus 20 may initiate, provide for, or terminate interactions between active stylus 20 and one or more devices 8 or one or more users, as described above. Particular interactions between active stylus 20 and device 8 may occur when active stylus 20 is contacting or in proximity to device 8. As an example and not by way of limitation, a user may perform a gesture or sequence of gestures, such as shaking or inverting active stylus 20, while active stylus 20 is hovering above touch-sensitive area 54 of device 8. Active stylus may interact with device 8 based on the gesture performed with active stylus 20 to initiate a pre-determined function, such as authenticating a user associated with active stylus 20 or device 8. Although this disclosure describes particular movements providing particular types of interactions between active stylus 20 and device 8, this disclosure contemplates any suitable movement influencing any suitable interaction in any suitable way.

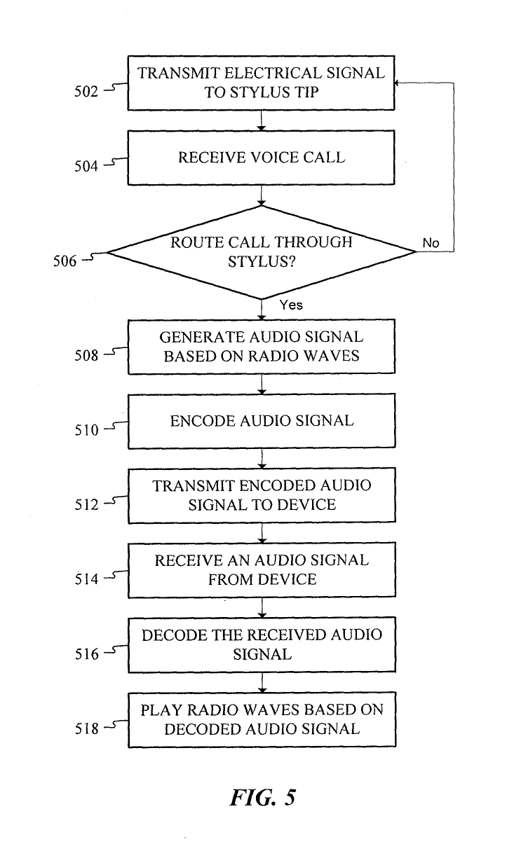

Active stylus 20 and device 8 may also communicate using a short-range wireless communication protocol such as those described above or other suitable protocol. Such communication is described below in more detail in connection with FIG. 5.

FIG. 5 illustrates an example method for providing voice capability by the active stylus of FIG. 2. The method starts at step 502, where an electrical signal is transmitted to tip 26 of active stylus 20. As described above, this signal may affect charge present at one or more capacitive nodes of touch sensor 10, allowing controller 12 to determine whether active stylus has provided a touch or proximity input and the location of such.

At step 504, device 8 receives a voice call. For example, another device coupled to device 8 through one or more networks may initiate a voice call with device 8 according to a telephone number, network address, or other identifier of device 8 or the user. In other embodiments, the user of device 8 may initiate a voice call to another device by interacting with device 8 or active stylus 20. At step 506, it is determined whether the voice call is to be routed through active stylus 20. Routing the voice call through active stylus 20 may include one or more of sending audio received from the caller to active stylus 20 (via device 8) for playing by speaker 23 of active stylus 20 and receiving (via device 8) audio from microphone 21 of active stylus 20 for transmission to the caller. Accordingly, routing the voice call may involve activating microphone 21 or speaker 23 of active stylus or deactivating a speaker or microphone of device 8.

Device 8 may determine whether to route the voice call through active stylus 20 in any suitable manner. For example, device 8 may automatically route the voice call through active stylus 20 if a short range wireless communication is established between device 8 and active stylus 20. As another example, device 8 may display a query to the user and route the voice call through active stylus 20 if the user responds affirmatively. As yet another example, device 8 may detect that the user has performed an action (such as pressing a button) with respect to device 8 or active stylus 20, and route the call through active stylus 20 in response to the detection.

If it is determined at step 506 that the voice call is not to be routed through active stylus 20, the voice call may continue by using audio input and output of device 8, and active stylus 20 may continue operating in a stylus mode, such that electrical signals generated by active stylus 20 may provide touch or proximity inputs to touch sensor 10 at step 502. In various embodiments, active stylus 20 may continue providing touch or proximity inputs to touch sensor 10 regardless of whether a voice call is occurring and whether the voice call is routed through active stylus 20 or device 8. In other embodiments, upon routing a voice call through active stylus 20, the generation of electrical signals by active stylus 20 to provide touch or proximity inputs to touch sensor 10 may be stopped to conserve power, since it may be unlikely that a user will attempt to provide input to the touch sensor 10 via active stylus 20 while holding the active stylus to his ear during the voice call.

If it is determined at step 506 that the voice call is to be routed through active stylus 20, then active stylus 20 may facilitate transfer of audio data between the user and the device 8. At step 508, microphone 21 of active stylus 20 may generate an audio signal based on radio waves received at the microphone. The radio waves may include a voice of the user, music, ambient noise, or other suitable audio input. Microphone 21 may convert the radio waves into an audio signal, such as an analog electrical signal. At step 510, the audio signal is encoded by audio codec 49. The encoding may include any one or more of an analog-to-digital conversion of the signal, compression of the signal, encryption of the signal, or other processing of the signal. At step 512, the encoded audio signal is transmitted to device 8 via a wireless communication link between active stylus 20 and device 8. The audio signal may then be sent to a device of the caller through one or more networks.

At step 514, active stylus receives an audio signal from device 8. The audio signal may include any suitable information. For example, the audio signal may include voice or other audio input from a device of the caller. At step 516, the received audio signal may be decoded by audio codec 49 of active stylus 20. The decoding may include any one or more of decryption of the audio signal, decompression of the audio signal, a digital-to-analog conversion of the audio signal, or other processing of the signal. At step 518, radio waves based on the decoded audio signal are played by speaker 23 of active stylus 20.

Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates particular components carrying out particular steps of the method of FIG. 5, this disclosure contemplates any suitable combination of any suitable components carrying out any suitable steps of the method of FIG. 5.

Certain embodiments of the invention may provide one or more technical advantages. A technical advantage of one embodiment includes providing voice capability in an active stylus. Another technical advantage of one embodiment includes initiating various functions from input at an active stylus based on an operating mode of the active stylus.

Herein, reference to a computer-readable storage medium encompasses one or more non-transitory, tangible computer-readable storage media possessing structure. As an example and not by way of limitation, a computer-readable storage medium may include a semiconductor-based or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A stylus comprising:
a controller operable to transmit a first electrical signal to a tip of the stylus, the first electrical signal configured to modify a charge at one or more capacitive nodes of a touch sensor of a computing device such that the proximity of the stylus to the one or more capacitive nodes may be detected by the computing device;
a microphone operable to generate a first audio signal based on a first set of sound waves received from a user of the stylus;
an audio codec operable to:
encode the first audio signal for wireless transmission to the computing device; and
decode a second audio signal received wirelessly from the computing device; and
a speaker configured to play a second set of sound waves based on the decoded second audio signal.

2. The stylus of claim 1, wherein the first audio signal and second audio signal comprise at least a portion of a voice call.

3. The stylus of claim 1, further comprising a sense unit operable to sense a second electrical signal present on one or more drive lines of the touch sensor and wherein the first electrical signal is derived from the second electrical signal.

4. The stylus of claim 1, further comprising a sense unit operable to sense a second electrical signal present on one or more drive lines of the touch sensor and wherein the first electrical signal is transmitted in response to reception of the second electrical signal.

5. The stylus of claim 1, wherein the first electrical signal has a dominant frequency that is different from each dominant frequency of a set of dominant frequencies of drive signals transmitted by a touch-sensor controller of the computing device to a plurality of drive lines of the touch sensor.

6. The stylus of claim 1, wherein the first electrical signal is further configured to increase the charge at the one or more capacitive nodes of the touch sensor.

7. The stylus of claim 1, further comprising a touch-sensitive capacitive input and wherein the controller is further operable to detect a touch at the touch-sensitive capacitive input.

8. The stylus of claim 7, wherein the controller is further operable to send an indication of the touch at the touch-sensitive capacitive input to the computing device.

9. The stylus of claim 7, wherein the stylus is operable to change a volume of the speaker in response to the touch at the touch-sensitive capacitive input.

10. The stylus of claim 7, wherein the stylus is configured to operate in a first mode in which the speaker is not active and a second mode in which the speaker is active and wherein a touch detected at the touch-sensitive capacitive input while the stylus operates in the first mode is associated with a predetermined function of the computing device and a touch detected at the touch-sensitive capacitive input while the stylus operates in the second mode is associated with a predetermined function of the stylus.

11. The stylus of claim 1, wherein the first audio signal comprises a voice command that initiates performance of a function by the computing device.

12. The stylus of claim 1, wherein the first audio signal is transmitted to the computing device using a first frequency that is different from a second frequency used to transmit the first electrical signal.

13. A method comprising:
transmitting, by a controller of a stylus, a first electrical signal to a tip of the stylus, the first electrical signal configured to modify a charge at one or more capacitive nodes of a touch sensor of a computing device such that the proximity of the stylus to the one or more capacitive nodes may be detected by the computing device;
generating a first audio signal based on a first set of sound waves received at a microphone of the stylus;
encoding the first audio signal and wirelessly transmitting the encoded first audio signal to the computing device;
decoding a second audio signal received wirelessly from the computing device; and
playing a second set of sound waves based on the decoded second audio signal.

14. The method of claim 13, wherein the first audio signal and second audio signal comprise at least a portion of a voice call.

15. The method of claim 13, further comprising changing a volume of the speaker in response to a touch at a touch-sensitive capacitive input of the stylus.

16. The method of claim 13, further comprising:
operating in a first mode in which the speaker is not active;
operating in a second mode in which the speaker is active;
associating a touch detected at a touch-sensitive capacitive input of the stylus while operating in the first mode with a predetermined function of the computing device; and
associating a touch detected at the touch-sensitive capacitive input of the stylus while operating in the second mode with a predetermined function of the stylus.

17. One or more computer-readable non-transitory storage media embodying logic that is operable when executed to:
transmit, by a controller of a stylus, a first electrical signal to a tip of the stylus, the first electrical signal configured to modify a charge at one or more capacitive nodes of a touch sensor of a computing device such that the proximity of the stylus to the one or more capacitive nodes may be detected by the computing device;
generate a first audio signal based on a first set of sound waves received at a microphone of the stylus;
encode the first audio signal and wirelessly transmitting the encoded first audio signal to the computing device;
decode a second audio signal received wirelessly from the computing device; and
play a second set of sound waves based on the decoded second audio signal.

18. The media of claim 17, wherein the first audio signal and second audio signal comprise at least a portion of a voice call.

19. The media of claim 17, wherein the logic is further operable to change a volume of the speaker in response to a touch at a touch-sensitive capacitive input of the stylus.

20. The media of claim 17, wherein the logic is further operable to:
operate in a first mode in which the speaker is not active;
operate in a second mode in which the speaker is active;
associate a touch detected at a touch-sensitive capacitive input of the stylus while operating in the first mode with a predetermined function of the computing device; and
associate a touch detected at the touch-sensitive capacitive input of the stylus while operating in the second mode with a predetermined function of the stylus.
